(19) United States
(12) Patent Application Publication
(10) Pub. No.: US 2019/0375240 A1
(43) Pub. Date: Dec. 12, 2019

(54) A NOVEL NYLON 6.6 CAP PLY

(71) Applicant: Kordsa Teknik Tekstil Anonim Sirketi., Kocaeli (TR)

(72) Inventor: Mehmet Sadettin FIDAN, ISTANBUL (TR)

(73) Assignee: Kordsa Teknik Tekstil Anonim Sirketi., Kocaeli (TR)

(21) Appl. No.: 15/739,789

(22) PCT Filed: Oct. 13, 2016
(86) PCT No.: PCT/TR2016/050380

§ 371 Date: Dec. 26, 2017

(51) Int. Cl. B60C 9/00; B60C 9/18; B60C 9/20; B60C 9/22

(52) U.S. Cl. CPC B60C 9/005; B60C 9/1821; B60C 9/2009; B60C 2009/2295; B60C 2009/0092; B60C 2009/2285; B60C 9/2204

(57) ABSTRACT

The present invention relates to a novel tire cord fabric or strip made of alternating a plurality of first nylon 6.6 cords and a plurality of second nylon 6.6 cords having different twists. Such a novel tire cord fabric or strips improve high speed durability, tread separation resistance and impact resistance when used as zero degree spirally wound cap ply on the belt package in pneumatic radial tires.

### CROSS REFERENCE TO RELATED APPLICATIONS

This application is the national phase entry of International Application No. PCT/TR2016/050380, filed on Oct. 13, 2016, the entire content of which is incorporated herein by reference.

### TECHNICAL FIELD

The present invention relates to a novel tire cord fabric or strip comprising alternate nylon 6.6 cords having different twists. Such a novel tire cord fabric or strip improves high speed durability, tread separation resistance and impact resistance when used as zero degree spirally wound cap ply on belt package in pneumatic radial tires.

### BACKGROUND OF THE INVENTION

Under high speed conditions, the outer diameter of the tire increases due to the centrifugal forces generated by steel cord belt package and tread. Such a diameter increase or tire growth increases the pantographic movements of the belt edge cords leading to the crack initiations, crack propagations and at the end belt edge separations.

On the other hand, the temperature rise at belt edges under high speed conditions might cause local adhesion degradation of the textile cap ply strip and leads to local cap ply-tread separations which may subsequently result in belt edge separations in a short time due to non-uniform stress distributions.

The cap ply layer wound on belt package circumferentially prevents excessive tire growth under high speed conditions by applying compressive forces (restraining force) on heavy belt package made of cross-ply steel cord layers. In order to enhance the restraining force, high cord count (epdm) cap ply strips are usually used (e.g. Nylon, 1400x2, 110 epdm or Nylon 1400x1, 140 epdm etc.).

Currently, most widely used cap ply materials are nylon 6.6 and aramid/nylon hybrid cords which are spirally wound on belt package at 0 to 5 degrees to equatorial plane of the tire.

Nylon cords have excellent fatigue resistance under bending and axial compression, and bi-elastic tensile characteristic enabling easy processing during tire building. Additionally, thermal shrink force generation with increasing service temperature under high speed conditions improves belt edge separation resistance and high speed durability.

It is well known the hybrid cords comprising high and low modulus yarns having bi-elastic tensile behavior are also used as cap ply in high speed tires. The low modulus component of hybrid cord enables easy belt package lifting without excessive tight cord formation due to its high extensibility and the high modulus component becomes effective in service conditions. By using hybrid cords as cap ply, the total thickness of the cap ply layer and rubber content can be decreased, and the high modulus component of the hybrid cord enhances the restraining force and improves high speed durability.

U.S. Pat. No. 4,284,117 describes a nylon cap ply which is formed from single yarns rather than cords. The cap ply is thinner than conventional cap plies having superior flexibility and heat dissipation characteristics. But the limited fatigue resistance of the single ply cords is the primary drawback of this application. The twist increase to improve the fatigue resistance leads to drastic modulus and restraining force drop.

U.S. Pat. No. 5,115,853 describes a radial tire having a cap ply structure disposed radially outwardly of the belt reinforcing structure. The cap ply structure comprises side by side nylon cords of 420x2 having cord twist of not greater than 280 tpm. The limited twist, in this case, low twist (low helix angle) has negative effects on fatigue resistance and impact resistance.

U.S. Pat. No. 2006/0237113 describes a zero degree belt reinforcing layer made of the alternately disposed at least one first elongated element is a hybrid cord including at least one high-elastic modulus filament and at least one low-elastic modulus filament twisted together. An elastic modulus of the at least one second elongated element is lower than an elastic modulus of the at least first elongated element. Such a cap ply reinforcement is not sufficiently effective at belt edges due to limited shrinkage and shrink force of the hybrid cords compared with nylon.

U.S. Pat. No. 6,799,618 describes a textile cap ply structure which is superimposed radially outwardly to the belt assembly is reinforced with cords being made of materials including nylon and aramid. At initial elongation of the cords, the primary load bearing yarns are nylon yarns, and after appreciable elongation the primary load bearing yarns are the aramid yarns. This is a conventional hybrid cord as cap ply with reduced impact resistance.

US Patent No. 2013/0025758 describes a high performance pneumatic radial tire for passenger cars which uses a hybrid cord composed of two ply aramid yarn and single ply nylon yarn having different twist counts for the first twist and different twist counts for the second twist, as a cap ply, and thereby has improved high speed durability and steering stability. This is also a conventional hybrid cord as cap ply with reduced impact resistance.

### SUMMARY OF THE INVENTION

The present invention relates to a novel tire cord fabric or strip comprising the alternately disposed parallel nylon 6.6 cords having different twists. Such a novel tire cord fabric or strips improve high speed durability, tread separation resistance and impact resistance when used as zero degree spirally wound cap ply in pneumatic radial tires.

As well known, nylon 6.6 has excellent fatigue resistance and bi-elastic tensile behaviour which makes the lifting process possible without forming tight cords, and provides sufficient restraining force under high speed conditions. But due to low initial modulus of nylon 6.6 cord, it is necessary to use high epdm (ends per decimeter) fabrics or strips as cap ply to reach the sufficient restraining force on the belt package (FIG. 1).

On the other hand, the cord-to-cord distance (rivet) in such fabrics or strips are too narrow which makes the rubber penetration difficult between the cords without scorch. Additionally, the rubber cracks can easily initiate between the cords having narrow rivet under dynamic conditions due to high shear stresses.

According to the invention, the nylon 6.6 cords having different twists in the cap ply strips have different modulus (or LASE), and different thermal shrink force values. During lifting (expansion) in the curing process, low twist nylon 6.6 cords (high modulus, low extensible cords) are loaded much higher than that of high twist cords (low modulus, high extensible cords). In addition to higher cord tensions, the low twist nylon cords under higher loading generate higher thermal shrink force (contraction force) at curing temperature. As a result of higher cord loading and higher thermal shrink force, low twist nylon cords penetrate the skim compound more than high twist cords.

As a result of different penetration levels of low and high twist nylon 6.6 cords in skim compound, the mono-ply cap strip layer becomes partially two-layer (wavy) cap strip. (FIG. 2)

### Definitions

Cord: The reinforcement element formed by twisting together two or more plied yarns.

Denier: The gram weight of yarn having 9,000 meter length.

Dtex: The gram weight of yarn having 10,000 meter length.

LASE: Load At Specified Load

7% LASE: Load At 7% Elongation in load elongation curve

Linear density: Weight per unit length as g/dtex or g/d(denier)

Restrainig force: Force applied by cap ply on belt package during driving to prevent tire growth

Total linear density: The sum of the nominal linear densities of the ply yarns of the cord

Two-ply cord: Cord prepared by twisting together two plied yarns

Three-ply cord: Cord prepared by twisting together three plied yarns

Twist: Number of turns per meter (t/m or tpm)

Warp: The set of yarn or cord in all woven fabrics, that runs lengthwise and parallel to the selvage

and is interwoven with the filling.

### BRIEF DESCRIPTION OF THE DRAWINGS

FIG. 1 is a cross-sectional view of a conventional (prior art) nylon cap ply on cross-ply steel cord belt package after curing process.

wherein a is cross ply steel cord belt package;

b is conventional cap ply on belt package;

c is tread.

FIG. 2 is a cross-sectional view of a nylon cap ply according to the invention on cross-ply steel cord belt package after curing process.

wherein a is cross ply steel cord belt package;

b is cap ply on belt package according to the invention;

c is tread.

FIG. 3A is a cross-sectional view of nylon cap ply cord arrangements according to the invention on cross-ply steel cord belt package, (1) before curing process, (2) after curing process;

A: Nylon 6.6 cord with higher twist or higher twist multiplier having lower modulus;

B: Nylon 6.6 cord with lower twist or lower twist multiplier having higher modulus;

H: Penetration difference of A and B cords in rubber matrix.

FIG. 3B is a top view of nylon cap ply strip made of A (higher twist, lower modulus, lower tension) and B (lower twist, higher modulus, higher tension) cords.

FIG. 4A is a cross-sectional view of nylon cap ply with side-by-side paired cords according to invention on cross-ply steel cord belt package, (3) before curing process, (4) after curing process;

FIG. 4B is a top view of side-by-side (paired) A (higher twist, lower modulus, lower tension) and B (lower twist, higher modulus, higher tension) cords in cap ply strip.

FIG. 5 shows the cord-to-cord distance (rivet area, spacing) changes after curing process;

S1: Cord-to-cord distance between A and B before process expansion and curing;

S2: Cord-to-cord distance between A and B after process expansion and curing;

S3: Cord-to-cord distance between A and A after process expansion and curing;

S4: Cord-to-cord distance between B and B after process expansion and curing.

FIG. 6 shows 1+2+1 cap ply cord arrangements;

(1)—A+B+B+A+B+B+A+. . . cord arrangement before process expansion and curing;

(2)—A+B+B+A+B+B+A+. . . cord arrangement after process expansion and curing.

FIG. 7 shows 2+1+2 cord arrangements;

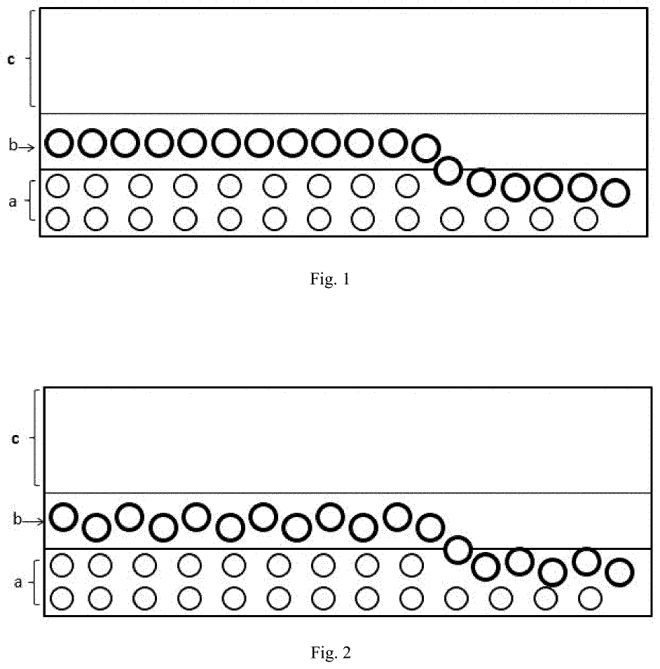

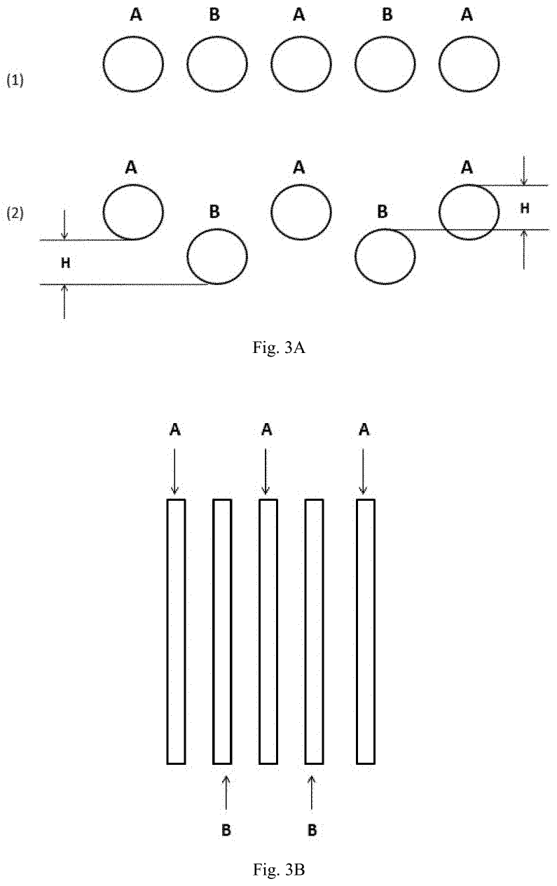

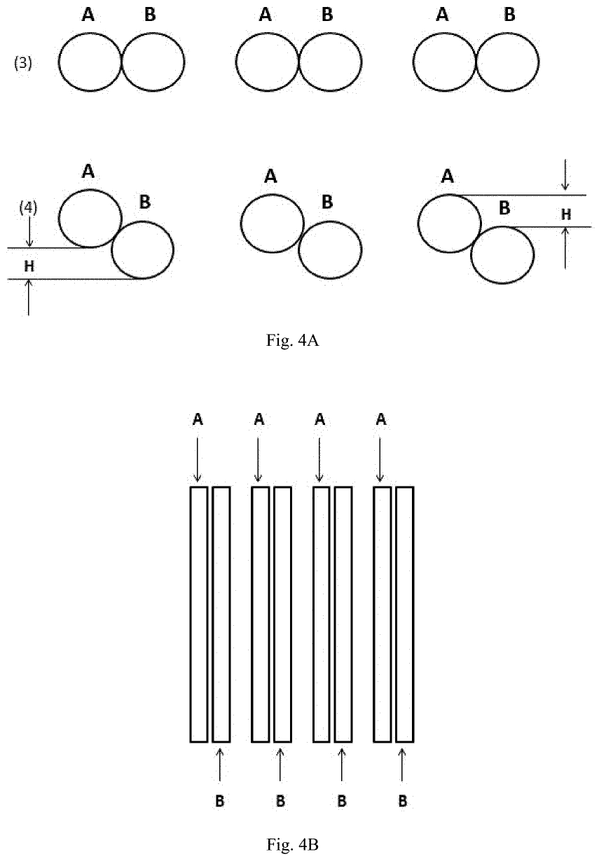

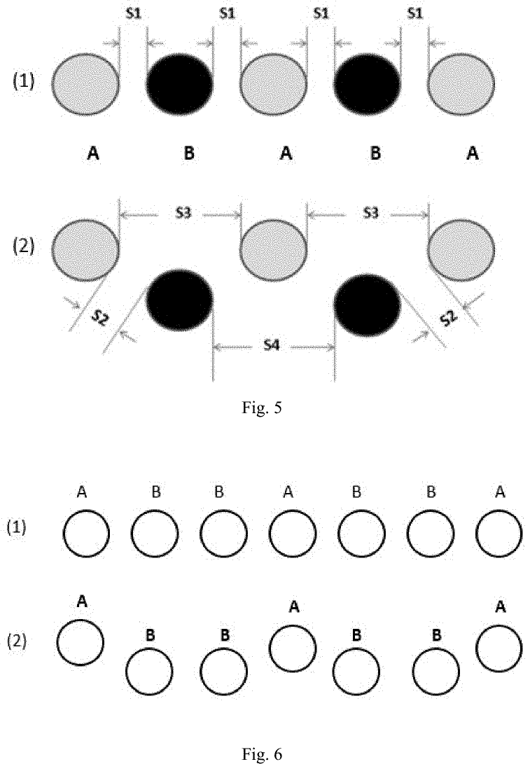

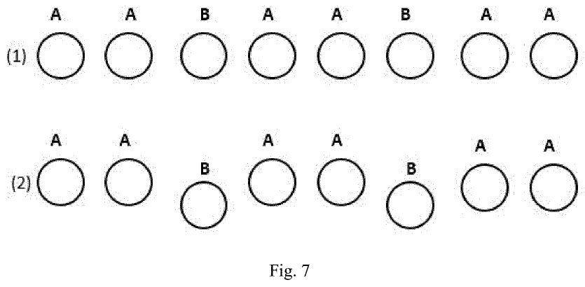

(1)—A+A+B+A+A+B+A+A+. . . cord arrangement before process expansion and curing;

(2)—A+A+B+A+A+B+A+A+. . . cord arrangement after process expansion and curing.

### DETAILED DESCRIPTION OF THE INVENTION

According to the invention, the spirally wound cap ply fabrics or cap ply strips on belt package of the pneumatic radial tires in circumferential direction, having alternately disposed parallel nylon 6.6 warp cords with different twist levels;
improves the high speed durability due to high modulus of low twist nylon cords, and the increased cord-to-cord distances (less shear stresses) between the cords (cord shiftings in vertical direction, two layer or zig-zag formation), (FIG. 3A, FIG. 3B and FIG. 5).
improves the impact resistance of belt package due to higher energy absorption of high twist, and high extensible nylon cords
and also improves the tread-cap ply separation resistance due to the wavy surface structure of the cap ply. The zig-zag surface enhances also mechanical bonding between cap ply and tread compound.

The first nylon cords (higher twist cord, A) and second nylon cords (lower twist corsi B) in cap ply strip are two and/or three-ply cords.

The angle of spirally wound cap ply strips to circumferential center line (or equatorial plane of the tire) is 0 to 5°.

In order to obtain the advantages mentioned above, the minimum twist difference between the alternate nylon cords having the same total cord dtex, should be 50, preferably 100 tpm (e.g. first cord, 1400x2, Z/S, 350/350 tpm, and second cord, 1400x2, Z/S, 250/250 tpm). But minimum cord (cable) twist must not be less than 150 tpm.

If the cord twist difference is less than 50 tpm between the first and second cords, the LASE, modulus or extensibility difference between the first and second cords becomes insignificant. Under those conditions, the wavy cap ply surface can not be created on the belt package of the tire.

On the other hand, the twist difference between the first and second cords must not exceed the 50% of the first cord twist (higher twist cord, A), for example 350 tpm vs. 175 tpm.

The total linear density of the cords is minimum 500 dtex and maximum 6,000 dtex. The cap ply cords having less than 500 dtex are too thin and LASE values are too low which can not provide enough restraining force even with very high cord counts (epdm). Besides this drawback, during process lifting and curing, they can cut the skim compound of the belt layer and contact to steel cords. The cap ply cords having higher than 6,000 dtex are too thick and requires too much rubber for coating. The potential drawback for such cords in tire is increased rolling resistance and heat build-up in the crown area.

The total linear density difference between the first and second cords is less than 15%. Preferably, the total linear densities of first and second cords should be same.

According to the invention, the sequence of the higher and lower twist nylon cords which are parallel to each other in a cap ply strip is in a alternating form as follows; A+B+A+B+A+B+. . . and so on, wherein A is the first cord with higher twist, and B is the second cord with lower twist compared to A. Such a cap ply strip creates a uniform wavy surface after curing process, which bonds to tread compound strongly improving tread separation resistance under high speed conditions.

According to the invention, the sequence of the higher and lower twist nylon cords which are parallel to each other in a cap ply strip is in a alternating form as follows AB+AB+AB+. . . and so on, as paired cords, wherein A is the first cord with higher twist, and B is the second cord with lower twist compared to A.

According to the invention, the sequence of the higher and lower twist nylon cords which are parallel to each other in a cap ply strip is in a alternating form as follows A+B+B+A+B+B+A +B+B+. . . and so on, wherein A is the first cord with higher twist, and B is the second cord with lower twist compared to A.

According to the invention, the sequence of the higher and lower twist nylon cords which are parallel to each other in a cap ply strip is in a alternating form as follows A+A+B+A+A+B+A +A+B+. . . and so on, wherein A is the first cord with higher twist, and B is the second cord with lower twist compared to A.

According to the invention, the cord count in strip is minimum 70 epdm (ends per decimeter). In case of cord counts lower than 70 epdm, the effectiveness of surface waviness is not enough for mechanical bonding to tread.

According to the invention, the difference between the 7% LASE values of the first and second nylon cords is minimum 15%, and preferably 25% (7% LASE values are determined according to ASTM D885-16).

According to the invention, the width of the cap ply strips is 8 to 25 mm, preferably 10 to 15 mm.

What is claimed is:

1. A cap ply strip, wherein the cap ply strip is made of a plurality of first nylon 6.6 cords and a plurality of second nylon 6.6 cords, wherein the plurality of first nylon 6.6 cords and the plurality of second nylon 6.6 cords are parallel and alternately disposed; wherein the cap ply strip is circumferentially wound on a belt package of a pneumatic radial tire;
wherein a difference between the twist numbers of the plurality of first nylon 6.6 cords and the plurality of second nylon 6.6 cords in the cap ply strip is at least 50 tpm;
wherein the twist number of the plurality of second cords is not less than 50% of the twist number of the plurality of first cords; wherein the plurality of the first nylon 6.6 cords are a plurality of higher twist cords B and the plurality of the second nylon 6.6 cords are a plurality of lower twist cords A.

2. The cap ply strip according to claim 1, wherein the plurality of first nylon 6.6 cords and the plurality of second nylon 6.6 cords are respectively two-ply cords.

3. The cap ply strip according to claim 1, wherein the plurality of first nylon 6.6 cords and the plurality of second nylon 6.6 cords are respectively three-ply cords.

4. The cap ply strip according to claim 1, wherein the difference between the twist numbers of the plurality of first nylon 6.6 cords and the plurality of second nylon 6.6 cords is greater than or equal to 100 tpm.

5. The cap ply strip according to claim 1, wherein a linear density of all the nylon 6.6 cords are greater than or equal to 500 dtex and less than or equal to 6,000 dtex.

6. The cap ply strip according to claim 1, wherein a difference between the linear densities of the plurality of first nylon 6.6 cords and the plurality of second nylon 6.6 cords is less than 15%.

7. The cap ply strip according to claim 1, wherein the linear density of the plurality of first nylon 6.6 cords is equal to that of the plurality of second nylon 6.6 cords.

8. The cap ply strip according to claim 1, wherein an arrangement of the plurality of first nylon 6.6 cords and the plurality of second nylon 6.6 cords in the strip is as follows: A+B+A+B+A+B and repeats.

9. The cap ply strip according to claim 1, wherein an arrangement of the plurality of first nylon 6.6 cords and the plurality of second nylon 6.6 cords in the strip is as follows: AB+AB+AB and repeats as a plurality of paired cords.

10. The cap ply strip according to claim 1, wherein an arrangement of the plurality of first nylon 6.6 cords and the plurality of second nylon 6.6 cords in the strip is as follows: A+B+B+A+B+B+A+B+B+A and repeats.

11. The cap ply strip according to claim 1, wherein an arrangement of the plurality of first nylon 6.6 cords and the plurality of second nylon 6.6 cords in the strip is as follows: A+A+B+A+A+B+A+A+B and repeats.

12. The cap ply strip according to claim 1, wherein a cord count in the strip is greater than or equal to 70 epdm (ends per decimeter).

13. The cap ply strip according to claim 1, wherein a difference of the 7% LASE values between the plurality of first nylon 6.6 cords and the plurality of second nylon 6.6 cords is minimum greater than or equal to 15%;
wherein the 7% LASE values are determined according to ASTM D885-16.

14. The cap ply strip according to claim 1, wherein a difference of the 7% LASE values between the plurality of first nylon 6.6 cords and the plurality of second nylon 6.6 cords is greater than or equal to 25%;
wherein the 7% LASE values are determined according to ASTM D885-16.

15. The cap ply strip according to claim 1, wherein a width of the cap ply strip is greater than or equal to 8 mm and less than or equal to 25 mm.

16. The cap ply strip according to claim 1, wherein a width of the cap ply strip is greater than or equal to 10 mm and less than or equal to 15 mm.
